(19) United States
(12) Patent Application Publication
(10) Pub. No.: US 2024/0020719 A1
(43) Pub. Date: Jan. 18, 2024

(54) NFT AND VIRTUAL CURRENCY PURCHASE SYSTEM AND METHOD USING POINTS

(71) Applicant: MinesSoft, Inc., Seoul (KR)

(72) Inventor: Hyojoeng KIM, Seongnam-si (KR)

(21) Appl. No.: 18/184,808

(22) Filed: Mar. 16, 2023

(30) Foreign Application Priority Data
Mar. 17, 2022 (KR) 10-2022-0033229
Mar. 16, 2023 (KR) 10-2023-0034372

(51) Int. Cl. G06Q 30/0207; G06Q 30/0226

(52) U.S. Cl. CPC G06Q 30/0215; G06Q 30/0233; G06Q 30/0209

(57) ABSTRACT

The present invention relates to NFT and virtual currency purchasing system using points and the method thereof, and more particularly, to NFT and virtual currency purchasing system using points and the method thereof, which can make the NFT and virtual currency be purchased by the points obtained from brands, stores, and apps and can make the purchased NFT and virtual currency be paid at stores.

### CROSS-REFERENCE TO RELATED APPLICATIONS

This application claims priority to the Republic of Korea Patent Application No. 10-2023-0034372, filed on Mar. 16, 2023, which claims priority to the Republic of Korea Patent Application No. 10-2022-0033229, filed on Mar. 17, 2022, which is incorporated by reference herein in its entirety.

### FIELD

The present invention relates to NFT and virtual currency purchasing system using points and the method thereof, more particularly to NFT and virtual currency purchasing system using points and the method thereof, which makes NFT and virtual currency be paid at stores, which are purchased by the points obtained from brands, stores, or apps, etc.

### BACKGROUND

A lot of stores, franchises, and credit card companies return a corresponding amount of money in the form of points, rewards, or various items if they use a certain amount.

Alternatively, the effect of promoting or increasing sales can be obtained by returning points, rewards, or various items through games, draws, or quizzes, etc.

However, these points or rewards can be used only when a certain point or reward is collected, or if it is too small, customers do not mind it and it often expires, so the above effect is not properly taken.

Meanwhile, in recent years, virtual currencies (coins) such as Bitcoin and Ethereum are used in the virtual world (metaverse) or in reality. In addition, many NFTs (Non-Fungible Tokens), which prove the electronic uniqueness of movies, music, and art by making them the only digital being using blockchain technology, are being manufactured, and systems for distributing and trading them are becoming active.

These virtual currencies and NFTs can be used to purchase items in the virtual world, but there are still many restrictions on purchasing items in the real world, and there are many problems with real-world payments because their value is not unified and keeps changing.

In other words, Bitcoin fluctuates a lot depending on the market price on the day, making it difficult to determine on what basis it can be exchanged for goods in the real world, and the same is true of NFT.

### SUMMARY

Therefore, embodiments of the present invention are conceived to solve such problems in the art and provide an NFT and virtual currency purchase system and method thereof, which can make the NFT and virtual currency be purchased by the points obtained from brands, stores, and apps and can make the purchased NFT and virtual currency be paid at stores.

It will be understood that objects of the present invention are not limited to the above. The above and other objects of the present invention will become apparent to those skilled in the art from the detailed description of the following embodiments in conjunction with the accompanying drawings.

In order to solve the above-described problems, the present invention provides an NFT and virtual currency purchase system using points including a consumer terminal, a store terminal, and a headquarters server, wherein the consumer terminal includes a point accumulation unit in which points are accumulated, a purchase unit in which NFT or virtual currency or NFT and virtual currency can be purchased with the accumulated points, and a usage unit in which the NFT or virtual currency is used, wherein the headquarters server includes a manufacturing unit that manufactures the NFT or the virtual currency or the NFT and virtual currency, and a transaction unit in which the NFT or the virtual currency or the NFT and virtual currency is/are traded, and wherein the store terminal includes a verification unit that checks the NFT or the virtual currency or the NFT and virtual currency provided in the usage unit of the consumer terminal, and a payment unit that converts the NFT or the virtual currency or the NFT and virtual currency identified in the verification unit into the amount of money and that pays.

Here, the above point accumulation unit is characterized by including an action point obtaining unit that obtains points from at least one of the game or quizzes, a purchase point obtaining unit that obtains points by converting a certain percentage or amount of money into points after use in the store, and an event point obtaining unit that obtains points issued by at least one of a specific date, a specific season, or a specific event.

Here, the NFT manufacturing unit is characterized in that NFT is manufactured using blockchain technology for one of the brands, products, and characters used in the store.

Here, the virtual currency manufacturing unit is characterized in that virtual currency is manufactured using blockchain technology for one of the brands, products, and characters used in the store.

Here, the NFT payment unit is characterized by including an NFT conversion unit that converts the market amount of the NFT into a value amount based on a specific reference time.

In addition, the virtual currency payment unit is characterized by including a virtual currency conversion unit that converts the market amount of the virtual currency into a value amount based on a specific reference time.

In addition, the headquarters server is characterized by further including a store metaverse implementing the store on a metaverse.

In addition, the point, NFT, and virtual currency are characterized in that they can be used in the store metaverse.

In addition, the above-store metaverse is characterized by including a meta-store that implements the above store as it is, a meta-product that implements the above store's products as it is, and a meta-money used in the above-store metaverse.

In addition, here, the meta-money is characterized in that it is at least one of the points, NFT, and virtual currency.

In addition, here, the headquarters server is characterized by further including a product purchase matching unit in which real-world products corresponding to meta-products purchased at the meta-store are carried or delivered to the consumer.

In addition, it is characterized that the above points are at least one of the associated points where several brands are gathered, individual brand points, or individual store points.

In accordance with an another aspect of the present invention, a method of purchasing NFT and virtual currency using points which are accumulated from consumer terminals and can be used in stores, in a NFT and virtual currency purchase system comprising consumer terminals, store terminals, and headquarters servers, includes: in the consumer terminals, a point accumulation step in which points are accumulated, a purchase step in which NFT or virtual currency or NFT and virtual currency are purchased with the accumulated points, and a usage step in which the NFT or the virtual currency or the NFT and virtual currency is/are used; in the headquarters servers, a manufacturing step of manufacturing the NFT or the virtual currency or the NFT and virtual currency, and a transaction step in which the NFT or the virtual currency or the NFT and virtual currency is/are traded; and in the store terminals, a verification step of verifying the NFT or the virtual currency or the NFT and virtual currency provided in the usage step of the consumer terminals and a payment step of paying by converting the NFT or the virtual currency or the NFT and virtual currency verified in the verification step into an corresponding amount of money.

The NFT and virtual currency purchase system using points and the method thereof according to the present invention have the following effects.

First, it has the advantage of increasing the value of utilizing points and thus increasing the promotional effect by purchasing the NFT or the virtual currency with small points or rewards that are difficult for consumers to recognize and by using it in stores.

Second, it has the advantage of promoting brands or stores through the NFT or the virtual currency and being able to stably run a business in recognition of the value of the NFT or the virtual currency by connecting it with the real economy.

Third, it has the advantage of promoting brands or stores because consumers can purchase the NFT or the virtual currency which can become assets by way of the points obtained by consumers' efforts through games that include brands or store characters.

Fourth, it has the advantage of doubling the promotional effect and further increasing the value of the brand or store by manufacturing the NFT or the virtual currency using the character design of the brand or store.

Fifth, it has the effect of increasing sales by delivering products purchased on Metaverse to the real world and doubling the store's promotional effect by creating a meta-store where the points, the NFT, and the virtual currency can be used.

The effects of the present invention are not limited to the above-mentioned effects, and other effects not mentioned will be clearly understood by those skilled in the art from the description of the claims.

### BRIEF DESCRIPTION OF DRAWINGS

FIG. 1 is a diagram illustrating the overall configuration of the NFT and virtual currency purchase system using points according to one embodiment of the present invention.

FIG. 2 is a diagram schematically illustrating the purchase of brand A's NFT by points, use at each store of each brand, and points calculation in a server.

FIG. 3 is a diagram schematically illustrating the purchase of brand virtual currency by points, use in each store of each brand, and points calculation in a server.

FIG. 4 is a diagram illustrating a match of store, product, and consumer between in the real world and on a metaverse.

FIG. 5 is a block diagram of a computing device for performing various operations, according to embodiments.

### DETAILED DESCRIPTION

The advantages and features of the present invention and a method for achieving them will become apparent regarding the embodiments described below in detail together with the accompanying drawings. However, the present invention is not limited to the embodiments disclosed below but may be implemented in various forms, and these embodiments are provided only to ensure that the disclosure is complete and to fully inform the scope of the present invention to those skilled in the art. Throughout the specification, the same reference numerals refer to the same components.

The size or shape of the components shown in the drawings attached to the present specification may be exaggerated for clarity and convenience of description. It should be noted that in each drawing, the same configuration may be indicated by the same reference numerals. In addition, a detailed description of the functions and configurations of the known technology determined to unnecessarily obscure the gist of the present invention may be omitted.

The terms used in the present specification are used to describe specific embodiments and are not intended to limit the present invention. As used in the present specification, the singular form may include a plurality of forms unless the context points out other cases. In addition, when a part of the present specification “comprises or includes” a component throughout, this means that other components may be further included unless otherwise opposed.

When a component is referred to as “connected” or “accessed” to another component, it should be understood that it may be directly connected to or accessed to the other component, but other components may exist in the middle. On the other hand, when a component is referred to as “directly connected” or “directly accessed” to another component, it should be understood that no other component exists in the middle. Other expressions for explaining the relationship between components should be interpreted in the same way.

Terms such as the upper end, the lower end, the upper surface, the lower surface, or the upper part and the lower part used in the present specification are used to distinguish relative positions in components. For example, when the upper part of the drawing is referred to as the upper part and the lower part of the drawing is referred to as the lower part for convenience, the upper part may be referred to as the lower part without departing from the scope of the present invention.

Terms including ordinal numbers, such as -first, -second, and the like described in the present specification, may be used to describe various components, but the components are not limited thereto. The terms are only referred to distinguish that each component is a different component, are not limited to the order of manufacture, and the names thereof may not match in the detailed description of the invention and the claims.

All terms including technical or scientific terms used herein have the same meaning as those generally understood by those skilled in the art to which the present invention belongs unless otherwise defined. Terms such as those defined in commonly used dictionaries should be interpreted as having meaning consistent with the contextual meaning of the relevant technology and are not interpreted as ideal or excessively formal unless clearly defined in this specification.

Hereinafter, to describe an NFT and virtual currency purchase system using points according to an embodiment of the present invention, the present invention will be described with reference to the accompanying drawings.

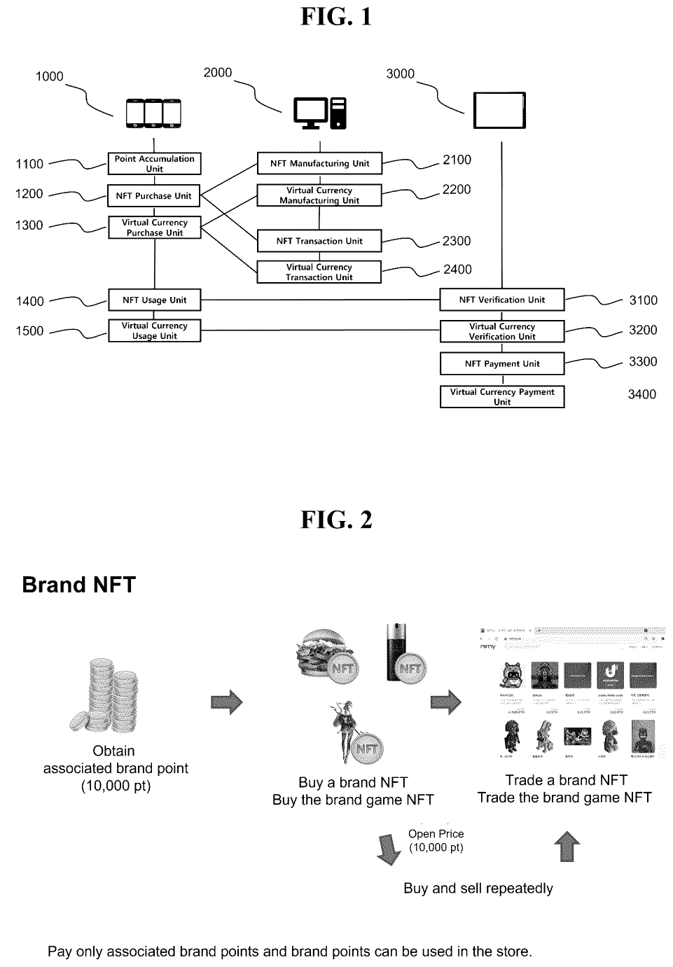

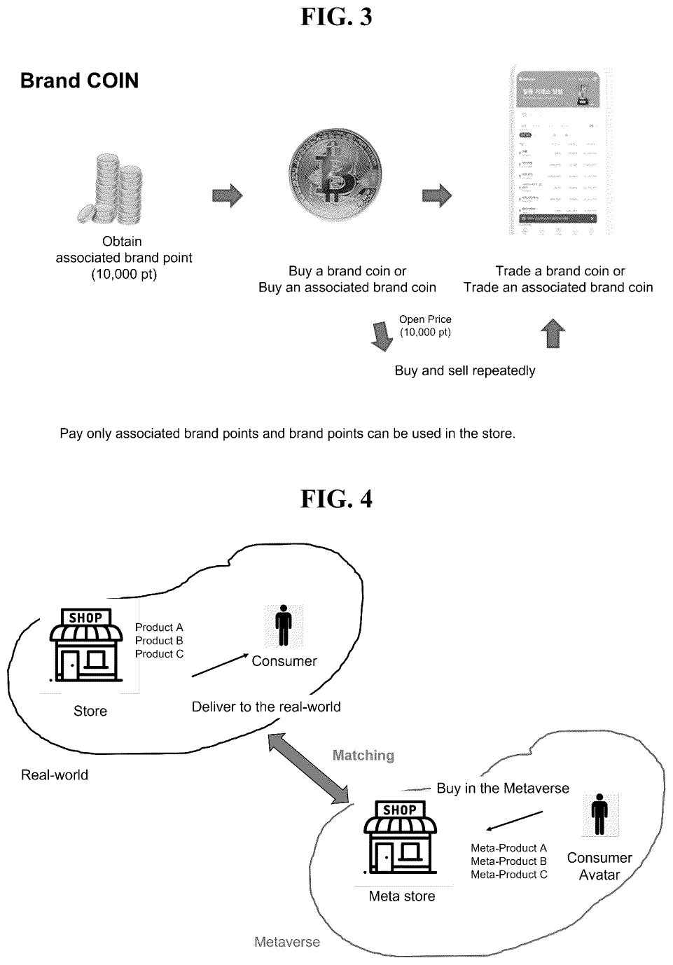

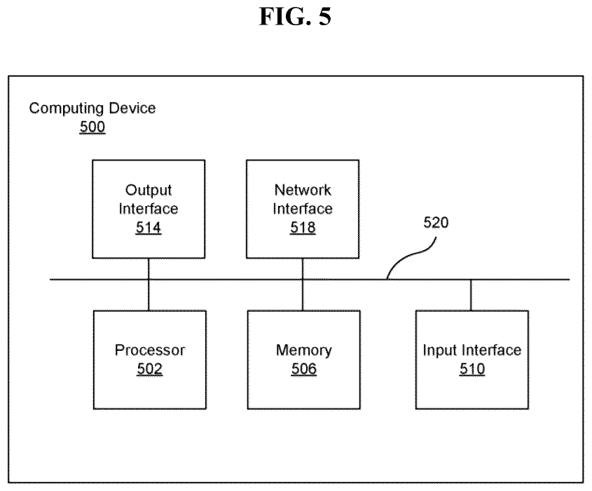

FIG. 1 is a diagram illustrating the overall configuration of the NFT and virtual currency purchase system using points according to one embodiment of the present invention, FIG. 2 is a diagram schematically illustrating the purchase of brand A's NFT by points, use at each store of each brand, and points calculation in a server, FIG. 3 is a diagram schematically illustrating the purchase of brand virtual currency by points, use in each store of each brand, and points calculation in a server, FIG. 4 is a diagram illustrating a match of store, product, and consumer between in the real world and on a metaverse and FIG. 5 is a block diagram of a computing device for performing various operations, according to embodiments.

Referring to FIG. 1, the NFT and virtual currency purchase system using the points according to the present invention includes a consumer terminal 1000, a store terminal 3000, and a headquarters server 2000. The above consumer terminal 1000 includes a point accumulation unit 1100 where points are accumulated, a purchase unit (not shown) that can purchase the NFT or the virtual currency or both the NFT and virtual currency with the above points, and a usage unit that can use the above NFT or virtual currency or both the NFT and the virtual currency. The headquarters server 2000 includes a manufacturing unit (not shown) that manufactures the NFT or the virtual currency or both the NFT and virtual currency and a trading unit (not shown) that trades the NFT or the virtual currency or both the NFT and virtual currency. The store terminal 3000 includes a verification unit (not shown) that verifies the NFT or the virtual currency or both the NFT and virtual currency provided by the usage unit of the consumer terminal 1000 and includes a payment unit (not shown) that converts the NFT or the virtual currency or both the NFT and virtual currency verified by the verification unit into a corresponding amount of money and pays.

Here, the purchase unit may include at least one of an NFT purchase unit 1200 which is capable of purchasing the NFT with the accumulated points and a virtual currency purchase unit 1300 which is capable of purchasing the virtual currency with the accumulated points, and the usage unit may include at least one of an NFT usage unit 1400 which uses the NFT and a virtual currency usage unit 1500 which uses the virtual currency.

In addition, the manufacturing unit may include at least one of an NFT manufacturing unit 2100 which manufactures the NFT and a virtual currency manufacturing unit 2200 which manufactures the virtual currency, and the transaction unit may include at least one of an NFT transaction unit 2300 in which the NFT is traded and a virtual currency transaction unit 2400 in which the virtual currency is traded.

In addition, the verification unit may include at least one of an NFT verification unit 3100 which verifies the NFT provided by the NFT usage unit 1400 of the consumer terminal 1000 and a virtual currency verification unit 3200 which verifies the virtual currency provided by the virtual currency usage unit 1500 of the consumer terminal 1000. The payment unit may include at least one of an NFT payment unit 3300 which converts the NFT verified by the NFT verification unit 3100 into a corresponding amount of money and a virtual currency payment unit 3400 that converts the virtual currency verified by the virtual currency verification unit 3200 into a corresponding amount of money.

The NFT and virtual currency purchase system using points according to the present invention is a system that allows the consumer to purchase the NFT or the virtual currency with the points when the points are obtained by playing games or purchasing products at stores and that allows the consumer to purchase products again with the purchased NFT or virtual currency. In other words, it is a system in which the NFT or the virtual currency is exchanged for real.

On the other hand, when NFT or virtual currency is listed, it is traded on the exchange, and when traded, the price fluctuates. In other words, the real value of the NFT or the virtual currency purchased with points changes. In this case, the consumer can purchase a product having a higher value than purchasing with the points accumulated at the store when exchanging the NFT or the virtual currency for a product, or if the real value of the NFT or the virtual currency decreases, the consumer may purchase a product with a lower value.

In the present invention, such matters are also included, but a system in which the real value of NFT or virtual currency generated in a specific ecosystem does not decrease is also included.

Here, a specific ecosystem refers to points, NFTs, and virtual currencies used only within the association, in which several brands, such as associated brands, gather to form a single association. Associated brands are formed by gathering individual brands, and individual brands are formed by gathering individual stores. In an embodiment, the associated brands may be formed by collecting brand A, brand B, and brand C, and in brand A, there may be individual stores such as brand A's first store, brand A's second store and so on.

When points which can be used in common only within the associated brand, and NFT or virtual currency which can be purchased with these points only are produced, the actual value of the NFT and the virtual currency is maintained and the consumer can purchase products at stores with the NFT or the virtual currency having the actual value.

Specifically, the consumer can purchase at least one of the NFTs or the virtual currencies of associated brands, individual brands, and individual stores with the points accumulated through games, events, and purchases of products at stores, and the value of the purchased NFT or that of the purchased virtual currency is recorded and stored as the corresponding points. For example, if the consumer purchases brand A's NFT with 10,000 points accumulated, brand A's NFT is recorded and stored as 10,000 points. Afterward, if you use brand A's NFT at the store, you can purchase a product by converting brand A's NFT into a value equivalent to 10,000 points.

Here, 10,000 points may be converted all equivalent to the whole product price, but only a certain percentage (10%) may be converted to be paid. In other words, when the consumer purchases a product worth 100,000 won, brand A's NFT stored as 10,000 points (or over 10,000 points) can be used.

On the other hand, user A, who owns an NFT, can also sell it to another user B without using it, in which case user B can purchase it for 11,000 points instead of 10,000 points. In other words, since brand A's NFT has 10,000 points stored and can be used in the store as it is, user B will purchase it at a higher price(point) because user A has no reason to trade at a lower price(point).

In the case of user B, only a certain number (e.g., 50 units) of brand A's NFT has been issued as a limited edition, and the price (point) is expected to rise in the future, so it will be purchased with points higher than 10,000 points. Another user C purchases at a higher price, and in this way, the storage point of the corresponding NFT may continue to rise. However, there is no case of the price falling down. In the case of user B and user C, there is no reason not to purchase the brand A's NFT because they have still the actual value equivalent to 11,000 points and 12,000 points each in either case that they have the points accumulated or that they have the brand A′ NFT respectively. In other words, the brand A′NFT is unconditionally purchased because its real value is guaranteed and there is only a possibility of rising in the future.

In this case, temporary points are created at the points which they have. In other words, user A has 10,000 points accumulated and user B has 11,000 points accumulated, and if user A purchases brand A's NFT for 10,000 points, user A still has 10,000 points.

And if user B purchases the user A's brand A's NFT for 11,000 points, user B will have brand A's NFT worth 11,000 points, and user A will have 11,000 points. In other words, in the case of user A, user A's accumulated points were 10,000 points, but by obtaining 11,000 points from user B, the total accumulated points (user A's and user B's) become 22,000 points, which increases by 1,000 points overall, which were 21,000 points before trading. The increased amount of 1,000 points should be covered by the association (or brand, or store). (Of course, it will be treated as part of the promotional expenses, such as games or events.)

If points increase indefinitely, it may be burdensome for associations (or brands or stores), but if the points are available only within the association (or brands or stores) and can be used only a certain percentage of sales, they remain as permanent discount coupon. In other words, if the points can be used only within 10% of the purchase amount at the store, it is the same as a 10% discount coupon. Even if 100 million points are accumulated or 100 million points of NFT are held, only 10% of the purchase amount will be available at the store.

As a result, the corresponding NFT can maintain its real value higher than its initial value, and the value-maintained NFT will eventually be used in stores, so the association (each brand, each store) will have the effect of increasing sales.

This means that one users' NFTs can be purchased with the other users' points accumulated, but the other users can purchase one users' NFT with only more points than the points one users used when they purchased the NFT, and only a certain percentage of store product's amount can be exchanged for the above NFT at the store.

Similar logic can be applied to virtual currency. In other words, in the case of virtual currency, 100 brand coins can be purchased if the accumulated points are 10,000 points. Here, 100 points will be 1 brand coin, and 1 brand coin can be used for as much as 100 points in the store.

On the other hand, 1 brand coin can be used for as much as 100 points when used in a store, but the points used can be set differently depending on the type of product. That is, in case of purchasing product A, 1 brand coin becomes 100 points, and in case of purchasing product B, it becomes 150 points. In this case, a user with the brand coin prefers to purchase product B, and if this user is not interested in product B, user B who is interested in product B can buy this brand coin for 120 points from the user. In other words, when 100 (points) brand coin (this means 1 brand coin) is purchased for 120 points by user B, 100 (points) brand coin will be worth 100 points for product A, and 150 points for product B.

Here, 100 (points) brand coin is set to be available for purchase from 100 points to 150 points. That is, the purchase price is set between the minimum and maximum values that can be used for the product, and the user can purchase accordingly.

Likewise, if the virtual currency is required to pay only a certain percentage of the purchased products' price, the generated temporary points can also be used as part of promotional expenses.

Of course, the virtual currency can be used for payment at its point price.

In the above embodiment, NFT can be purchased with points, but it can also be purchased with virtual currency, and the points, NFT, and virtual currency can all be used in the store. In other words, all can be used by converting into points at a certain ratio or different ratios.

Product A may be purchased with points of face value or virtual currency of higher value, or NFT of higher value than virtual currency. In one embodiment, when product A is priced at 10,000 won and can be paid with the points within 20% of product A's price, a brand coin or NFT with 1,000 points value can be converted to 1,100 points in case of the brand coin, and 1,200 points in case of the NFT. Of course, product B can be converted into a different ratio.

The point accumulation unit 1100 may include an action point obtaining unit 1110 (not shown) which obtains points from games or quizzes, a purchase point obtaining unit 1120 (not shown) which obtains points by converting a predetermined ratio or a predetermined amount of product purchase into points, and an event point obtaining unit 1130 (not shown) which obtains points received on a specific day, a specific season or a specific event.

The action point obtaining unit 1110 may allow a user to obtain points from a game or the like, and the more the accumulated points gather, the higher the difficulty level of the game becomes. The purchase point obtaining unit 1120 may reward a predetermined ratio or a predetermined amount as points when a user purchases a product at a store. In other words, 10,000 points can be accumulated by purchasing 100,000 won products. The accumulation rate may vary depending on the product, season or date (event day, specific day, and anniversary).

The event point obtaining unit 1130 may provide points in the form of coupons on anniversaries, birthdays, etc. It can be increased according to anniversaries, birthdays, the number of purchases, or the number of customer years (regular customers or long-term customers).

All of the above-obtained points are accumulated in the point accumulation unit, and when they are accumulated, the actual accumulating points may differ according to the accumulation conversion formula. That is, the action point obtaining unit may accumulate points as 1:0.5, the purchase point obtaining unit may accumulate points as 1:1, and the event point obtaining unit may accumulate points as 1:0.8.

The NFT manufacturing unit 2100 may manufacture NFT by using any one of a brand, a product, and a character used in the store through blockchain technology.

Associated brands, individual brands, products(goods), and characters of individual stores may be different, and each may be made into NFT. In other words, it can be manufactured as an associated brand's NFT, an individual brand's NFT such as brand A's NFT, and an individual store's NFT such as brand A's 1st store NFT. As will be described later, points (price) corresponding to NFT may be set differently depending on whether it is an associated brand, an individual brand, or an individual store, and the conversion value (conversion point) can be set differently.

The virtual currency manufacturing unit 2200 may manufacture virtual currency by using any one of a brand, a product, and a character used in the store through blockchain technology.

Similarly, associated brands, individual brands, products, and characters of individual stores may be different, and each may be produced in virtual currency. In other words, it can be produced as an associated brand virtual currency, an individual brand A's virtual currency, a brand B's virtual currency, and an individual brand A's 1st store virtual currency. Points (price) corresponding to virtual currency may be set differently depending on whether it is an associated brand, an individual brand, or an individual store, and the conversion value (conversion point) can be set differently. In addition, it may be set and produced as single virtual currency or common virtual currency may be used within the association. In this case, the conversion ratio with virtual currency may vary depending on whether it is an associated brand point, an individual brand point, or a store point, and in the store a user (consumer) can purchase the product only with virtual currency at a certain ratio of the product price, not with points.

The NFT payment unit 3300 may include an NFT conversion unit for converting the market amount of the NFT into a value amount based on a specific reference time.

“The market amount” means that if the NFT is listed, the price of the NFT can be converted into an external amount. In other words, a certain number of NFTs can be issued and purchased as points, but when the NFT is listed and traded externally, it can be valued more than purchase points or less than purchase points. In this case, when the NFT is used in the store, payment can be made based on the reference time.

In addition, as described above, in the NFT payment unit 3300, only a certain percentage of the purchased product(goods) price may be paid with the NFT and the NFT is converted into points recorded in it when it is paid.

The virtual currency payment unit 3400 may include a virtual currency conversion unit which converts the market amount of the virtual currency into a value amount based on a specific reference time.

Like the NFT payment unit 3300 described above, it may be traded according to the market price of the virtual currency.

The headquarters server 2000 may further include a store metaverse implementing the store on the metaverse.

The points, NFTs, and virtual currency can be used on the metaverse and various meta items can be purchased. Of course, even in this case, the point conversion formula can be applied. (The conversion ratio of points, NFT, and virtual currency may vary depending on whether they belong to an associated brand, individual brand, or store.)

The store metaverse may include a meta store that implements the store as it is, meta products that implement the store's products as it is, and meta money used in the store metaverse.

In other words, the same meta store as in the real world, the same meta products as in the real world, and meta money with the same value as in the real world are used. In other words, through matching the real world and the metaverse, if a product is purchased in real life, the corresponding meta product becomes to be purchased on a metaverse, and if a meta product is purchased on a metaverse, the corresponding product becomes to be purchased in real life, and delivered, or the ownership is transferred.

The meta money may be at least one of the points, the NFT, and the virtual currency.

The present invention may further include a product purchase matching unit in which a real world product corresponding to a meta product purchased at a meta store. As described above, when a meta product is purchased, the same product in real world may be delivered to the person who purchased the meta product in the meta store. In this case, real world users and avatars on the metaverse must be authenticated, and real world products and meta products on the metaverse must be authenticated with each other. In addition, real world products and meta products on the metaverse should have the same quantity of inventory management and should be matched and traced.

In accordance with an another aspect of the present invention, a method of purchasing NFT and virtual currency using points which are accumulated from consumer terminals and can be used in stores, in a NFT and virtual currency purchase system comprising consumer terminals, store terminals, and headquarters servers, includes: in the consumer terminals, a point accumulation step in which points are accumulated, a purchase step in which NFT or virtual currency or NFT and virtual currency are purchased with the accumulated points, and a usage step in which the NFT or the virtual currency or the NFT and virtual currency is/are used; in the headquarters servers, a manufacturing step of manufacturing the NFT or the virtual currency or the NFT and virtual currency, and a transaction step in which the NFT or the virtual currency or the NFT and virtual currency is/are traded; and in the store terminals, a verification step of verifying the NFT or the virtual currency or the NFT and virtual currency provided in the usage step of the consumer terminals and a payment step of paying by converting the NFT or the virtual currency or the NFT and virtual currency verified in the verification step into an corresponding amount of money.

The NFT and virtual currency purchase method using points indicates operation method of the above-described purchase system, the details of which are replaced by the above description.

FIG. 5 is a block diagram of a computing device 500 for performing various operations described herein, according to embodiments. The computing device 500 may include, among other components, a processor 500, a memory 506, an input interface 510, an output interface 514, a network interface 518, and a bus 520 connecting these components. Processor 502 retrieves and executes commands stored in memory 506. The memory 506 stores software components including, for example, operating systems and modules for performing various operations as described herein. The input interface 510 receives data from external sources. The output interface 514 is a component for providing the result of the computation in various forms. The network interface 158 enables the computing device 500 to communicate with other computing devices by a network.

As described above, although the preferred embodiment of the present invention is illustrated and described with reference to the drawings, the present invention is not limited to the above specific embodiment, and various modifications are possible by those of ordinary skill in the art without departing from the gist of the present invention claimed.

1. An NFT and virtual currency purchase system using points, comprising:
a consumer terminal;
a store terminal; and
a headquarters server,
wherein the consumer terminal comprises:
a point accumulation unit wherein points are accumulated;
a purchase unit wherein the NFT or the virtual currency or the NFT and virtual currency can be purchased with the accumulated points; and
a usage unit wherein the NFT or the virtual currency or the NFT and virtual currency can be used, and
wherein the headquarters server comprises:
a manufacturing unit wherein the NFT or the virtual currency or the NFT and virtual currency is/are manufactured; and
a transaction unit wherein the NFT or the virtual currency or the NFT and virtual currency is/are traded, and
wherein the store terminal comprises:
a verification unit wherein the NFT or the virtual currency or the NFT and virtual currency provided by the usage unit of the consumer terminal, are verified; and
a payment unit wherein the NFT, the virtual currency or both the NFT and virtual currency are converted into a corresponding amount of money to be paid.

2. The NFT and virtual currency purchase system using points according to claim 1, wherein the headquarters server further comprises a store metaverse implemented the store on a metaverse.

3. The NFT and virtual currency purchase system using points according to claim 2, wherein the points, the NFT and the virtual currency are used in the store metaverse.

4. The NFT and virtual currency purchase system using points according to claim 3, wherein the store metaverse comprises: a meta store implemented the store; a meta product implemented product of the store; and a meta money used in the store metaverse.

5. A method of purchasing NFT and virtual currency using points which are accumulated from a consumer terminal and can be used in stores, in a NFT and virtual currency purchase system comprising the consumer terminal, a store terminal, and a headquarters server, comprising:
in the consumer terminal, a point accumulation step wherein points are accumulated;
a purchase step wherein the NFT or the virtual currency or the NFT and virtual currency can be purchased with the accumulated points; and
a usage step wherein the NFT or the virtual currency or the NFT and virtual currency can be used, and
in the headquarters server, a manufacturing step wherein the NFT or the virtual currency or the NFT and virtual currency is/are manufactured; and
a transaction step wherein the NFT or the virtual currency or the NFT and virtual currency is/are traded, and
in the store terminal, a verification step wherein the NFT or the virtual currency or the NFT and virtual currency provided by a usage unit of the consumer terminal, is verified; and
a payment step wherein the NFT, the virtual currency or both the NFT and virtual currency are converted into an amount of money to be paid.
